(19) United States
(12) Patent Application Publication
(10) Pub. No.: US 2002/0026327 A1
(43) Pub. Date: Feb. 28, 2002

(54) Channel content management

(76) Inventors: Satyen V. Kothari, San Francisco, CA (US); Thor Muller, San Francisco, CA (US)

Correspondence Address: RITTER, LANG & KAPLAN, 12930 SARATOGA AE. SUITE D1, SARATOGA, CA, 95070, US

(21) Appl. No.: 09/938,845

(22) Filed: Aug. 24, 2001

Related U.S. Application Data
(60) Provisional application No. 60/227,670, filed on Aug. 24, 2000.

(51) Int. Cl. G06F 17/60

(52) U.S. Cl. 705/1

(57) ABSTRACT

Innovative techniques for managing the sharing of content are provided. Content can be extracted from a distributor and the content sent to a server. The server can store the content and apply one or more rules and deliver the content to a publisher in a format that is specified by the publisher. Additionally, the server can track information regarding the access to the content so that the publisher can easily evaluate the effectiveness of the relationship with the distributor.

This application claims the benefit of U.S. Provisional Application No. 60/227,670, filed Aug. 24, 2000, which is hereby incorporated by reference.

### BACKGROUND OF THE INVENTION

The present invention relates to content sharing. More specifically, the invention relates to channel management of the sharing of content.

The Internet has made content sharing relationships more important than ever. Businesses are struggling to differentiate from a multitude of competitors by partnering to bundle value-added content, commerce and services within their core competencies. It has been estimated that the average company is jumbling or more alliances, with a steady increase in the number of these relationships by 30% or more each year.

Unfortunately, business' ability to support integrated content sharing relationships has not kept up with the explosion in their number and complexity. Elements to a successful content or commerce relationship include the rapid integration of offering and the close measurement of results. These basic requirements often frustrate even the best engineering teams, who may be pulled from mission-critical projects to build one-off solutions that are limited in their scope, functionality and scalability.

In a perfect world, each business would store their information the same way as every other business and would use the same techniques for describing their information. Because this is not the case, integrating content from different sources typically requires the tedious process of manually analyzing the source's content format, converting the content into a normalized format, generating the code or links to display the content, and tracking the results across the entire process. This process may have to be performed again if the content changes.

Implementation delays and technical hurdles are the consequences that too frequently derail sound relationship content sharing plans. Relationships that are intended to deliver high economic returns end up becoming costly resource drains, if they are even implemented at all. It would be beneficial to have innovative techniques for managing the sharing of content. It would be especially beneficial if sharing content among different sources is easy, customizable, dynamic, and allows all involved entities to evaluate the results of their relationships.

### SUMMARY OF THE INVENTION

The present invention provides innovative techniques for managing the sharing of content. As an example, content can be extracted from a distributor and the content sent to a server. The server can store the content and deliver the content to a publisher in a format that is specified by the publisher. The selection, design and delivery of the content can be constrained via various rules specified by the distributor or publisher. The server can track information regarding the access to the content so that the publisher can easily evaluate the effectiveness of the relationship with the distributor. Some specific embodiments of the invention are described below.

In one embodiment, the invention provides a computer-implemented method of delivering content. A server receives content from a distributor. The server applies one or more rules specified by a publisher or distributor to adjust the appearance of the content. The server then delivers the content to the publisher so that the content will appear as specified by the one or more rules. The server can also track and report on aspects of the process. In some embodiments, the content is displayed by the publisher on a web page.

In another embodiment, the invention provides a channel content management system. A distributor system stores content and a server receives the content from the distributor system. A server applies one or more rules specified by a publisher or distributor to adjust the appearance of the content. A publisher system receives the content from the server so that the content will appear as specified by the one or more rules. The server can also tracks and reports on aspects of the process.

In another embodiment, the invention provides a computer implemented method of delivering content. A server receives content from a distributor where the content will be displayed on a web page of a publisher. When the web page is displayed, a script in the web page accesses the server to receive the content. The server applies one or more rules specified by a publisher or distributor to adjust the appearance of the content as displayed on the web page. The server delivers the content to the publisher so that the content will appear on the web page as specified by the one or more rules. The server can also track and report on aspects of the process. In some embodiments, the content includes a link to the server and the server tracks information regarding traversal of the link.

In another embodiment, the invention provides a channel content management system. A distributor system stores content where the content will be displayed on a web page of a publisher system. A server receives the content from the distributor system and applies one or more rules specified by a publisher or distributor to adjust the appearance of the content displayed on the web page. A publisher system displays the web page and when the web page is displayed, a script in the web page accesses the server to receive the content so that the content will appear on the web page as specified by the one or more rules. The server can also track and report on aspects of the process.

Other features and advantages of the invention will become readily apparent upon review of the following description in association with the accompanying drawings, where the same or similar structures are designated with the same reference numerals.

### BRIEF DESCRIPTION OF THE DRAWINGS

FIG. 1 illustrates an example of a computer system that can be utilized to execute the software of an embodiment of the invention.

FIG. 2 illustrates a system block diagram of the computer system of FIG. 1.

FIG. 3 illustrates a network of computer systems that can be utilized to implement one embodiment of the invention.

FIG. 4 shows a flowchart of a process of delivering content from a distributor to a publisher so that the content will appear as specified by the publisher.

FIG. 5 shows a screen display of an embodiment that enables sharing of content.

FIG. 6 shows a flowchart of a process of managing content in a network-based system.

FIG. 7 shows a flowchart of a process of profiling a Publisher for shared content.

FIGS. 8A-8E show screen displays of an embodiment that provides profiling a Publisher's categories, target audience and regions.

FIG. 9 shows a flowchart of a process of managing relationships for sharing content.

FIGS. 10A-10C show screen displays of an embodiment that provides searching for potential partners, requesting relationships and accepting relationships.

FIG. 11 shows a flowchart of a process of specifying the display of content.

FIGS. 12A-12E show screen displays of an embodiment that provides creation of display cases, specifying how the display cases will be integrated and adjusting the appearance of the content in the display cases.

FIG. 13 shows a flowchart of a process of specifying business rules for the displaying of content.

FIGS. 14A-14B show screen displays of an embodiment that provides specification of business rules in the display of content in display cases.

FIG. 15 shows a flowchart of a process of generating reports regarding the shared content.

FIGS. 16A-16B shows screen displays of an embodiment that provides customization of reports that are generated regarding the shared content.

FIG. 17 shows a flowchart of a process of delivering content from a distributor to a publisher so that the content will appear on a Publisher as specified by the publisher.

### DETAILED DESCRIPTION OF PREFERRED EMBODIMENTS

In the description that follows, the present invention will be described in reference to embodiments that provide channel content management. More specifically, the embodiments will be described in reference to sharing content among different entities in a way that is easy, customizable, dynamic, and allows partners to evaluate the results of their relationships. However, embodiments of the invention are not limited to any particular environment, application or specific implementation. Therefore, the description of the embodiments that follows is for purposes of illustration and not limitation.

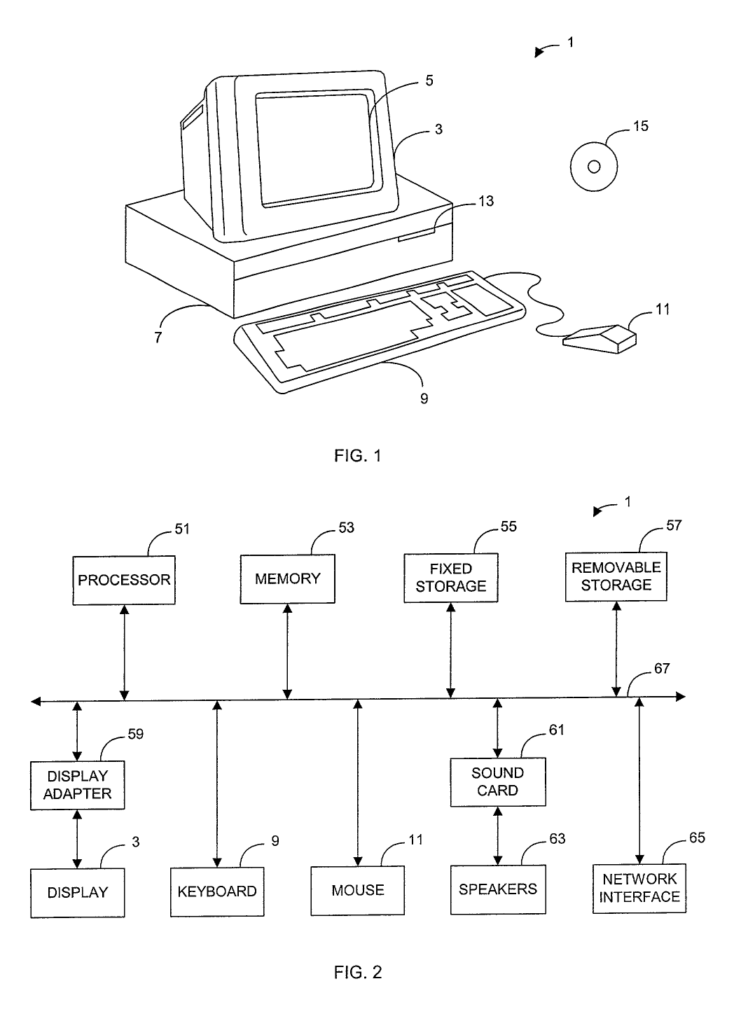

FIG. 1 illustrates an example of a computer system that can be used to execute the software of an embodiment of the invention. FIG. 1 shows a computer system 1 that includes a display 3, screen 5, cabinet 7, keyboard 9, and mouse 11. Mouse 11 can have one or more buttons for interacting with a graphical user interface. Cabinet 7 houses a CD-ROM drive 13, system memory and a hard drive (see FIG. 2) which can be utilized to store and retrieve software programs incorporating computer code that implements the invention, data for use with the invention, and the like. Although CD-ROM 15 is shown as an exemplary computer readable storage medium, other computer readable storage media including floppy disk, tape, flash memory, system memory, and hard drive can be utilized. Additionally, a data signal embodied in a carrier wave (e.g., in a network including the Internet) can be the computer readable storage medium.

FIG. 2 shows a system block diagram of computer system 1 used to execute the software of an embodiment of the invention. As in FIG. 1, computer system 1 includes monitor 3 and keyboard 9, and mouse 11. Computer system 1 further includes subsystems such as a central processor 51, system memory 53, fixed storage 55 (e.g., hard drive), removable storage 57 (e.g., CD-ROM drive), display adapter 59, sound card 61, speakers 63, and network interface 65. Other computer systems suitable for use with the invention can include additional or fewer subsystems. For example, another computer system could include more than one processor 51 (i.e., a multi-processor system) or a cache memory.

The system bus architecture of computer system 1 is represented by arrows 67. However, these arrows are illustrative of any interconnection scheme serving to link the subsystems. For example, a local bus could be utilized to connect the central processor to the system memory and display adapter. Computer system 1 shown in FIG. 2 is but an example of a computer system suitable for use with the invention. Other computer architectures having different configurations of subsystems can also be utilized.

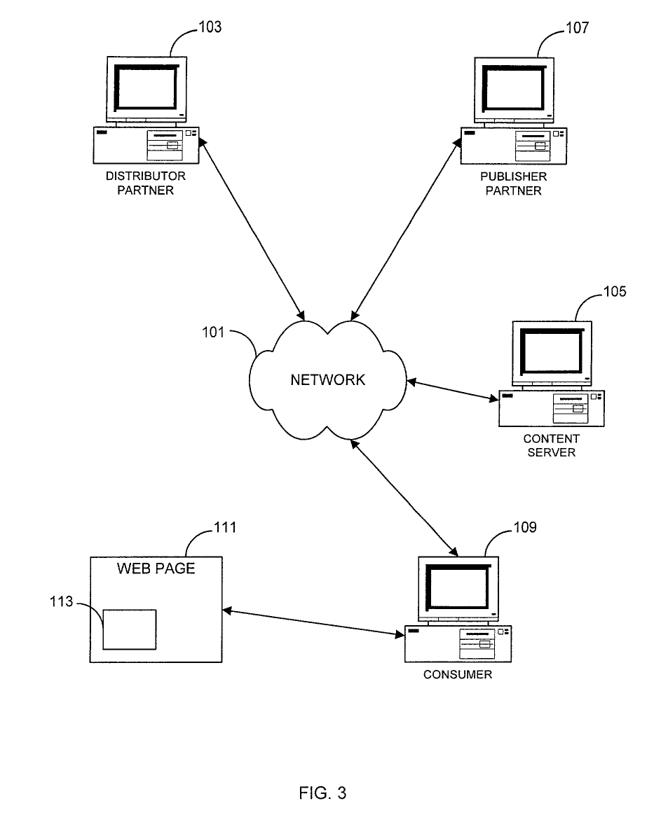

FIG. 3 shows a network of multiple computer systems. A network 101 provides communication between multiple computer systems and can be a wide area network (e.g., the Internet) or a local area network (e.g., an intranet). In a typical system, a distributor partner 103 has content that is to be shared with other partners. The content can be news, products, services, and the like and the content can be stored in any number of ways including on web pages, an FTP server, a database, and the like.

A publisher partner 107 desires to publish the content provided by distributed partner 103. In sharing the content, publisher partner 107 may desire to have the content appear to consumers in a way that is more consistent with the appearance of other content provided by the publisher partner. Therefore, publisher partner 107 specifies one or more rules that indicate how the content from distributor partner 103 should appear. The one or more rules specified by publisher partner 107 are stored on a content server 105.

Content server 105 receives content to be shared from distributor partner 103 and formats the content as specified by the one or more rule from publisher partner 107. The reformatted content is then delivered to publisher partner 107 to be presented to consumers. In this way, the original content stored by distributor partner 103 remains unchanged while publisher partner 107 can present the shared content in a way that is more consistent with the other content they are providing. For description purposes the term “distributor” will be used to describe one that provides shared content and the term “publisher” will be used to describe one that presents shared content. It should be understood, however, that these terms are relative to the content at issue as any partner can be both a distributor and a publisher.

In some embodiments, the distributor can set permissions to control modifications to the substance of the shared content. For example, one permission can allow the publisher to freely modify the substance of the content. Another permission may allow the publisher to modify the substance of the content if approval is given by the distributor, while another permission may deny or prohibit any modifications to the substance of the content.

As a simple example, assume that distributor partner 103 has products that can be sold through its partners. A description of such products may be stored in a database maintained by the distributor partner. The distributor and publisher partners have agreed to share content that describes a product that the distributor partner sells and the publisher partner is planning to offer for sale. Typically, the distributor and publisher partners will negotiate other details such as compensation for each partner relating to each sale.

It should be noted that the term content” is used in the generic sense. The invention is equally capable of handling pure content, product catalogs and web based applications.

As one might imagine, the appearance of the publisher partner's Publisher may be dramatically different from the Publisher of (or content provided by) the distributor partner. Publisher partner 107 specifies rules for formatting the appearance of the content describing the product so that the content will better blend with the publisher partner's Publisher. The rules are stored by and reformatting performed by content server 105.

Content server 105 is also capable of applying other rules that hel determine the selection of the content prior to display on Publisher partner 107. These rules could be determined based on relationship priorities, pricing, profit margins, customer profiles or any other parameters. Rules can also be applied to optimize the selection of the appropriate content over time based on popularity of certain content items relative to others.

When a consumer 109 accesses the publisher partner's Publisher, a web page 111 may be displayed. On web page 111 a portion 113 of the web page may be devoted to presenting the product from the distributor partner and publisher partner 107 has specified by rules how the content for the product should appear. Thus, the appearance of the content may make it impossible to tell that the content was from another source. Accordingly, with embodiments of the invention, shared content can be seamlessly and efficiently integrated.

In a preferred embodiment, portion 113 (also called a “display case”) is provided by content server 105. Additionally, when a consumer accesses content 113, the consumer is then interacting with content server 105. This allows content server 105 to better track information regarding access to shared content for such purposes as reporting, dynamically changing shared comment, and the like. Although a single display case is shown, typically a web page can contain multiple display cases.

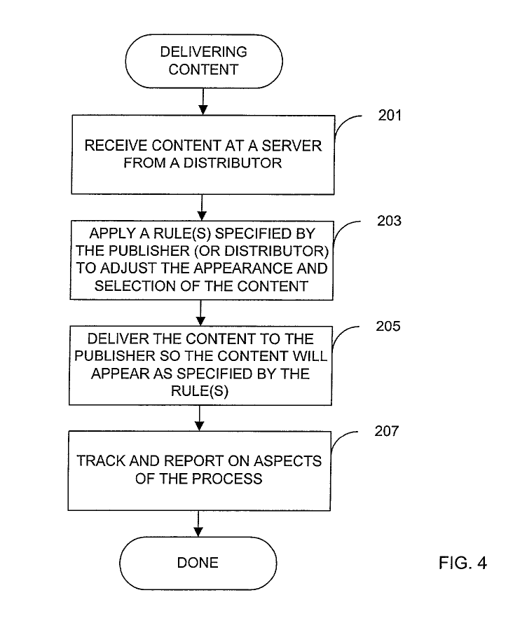

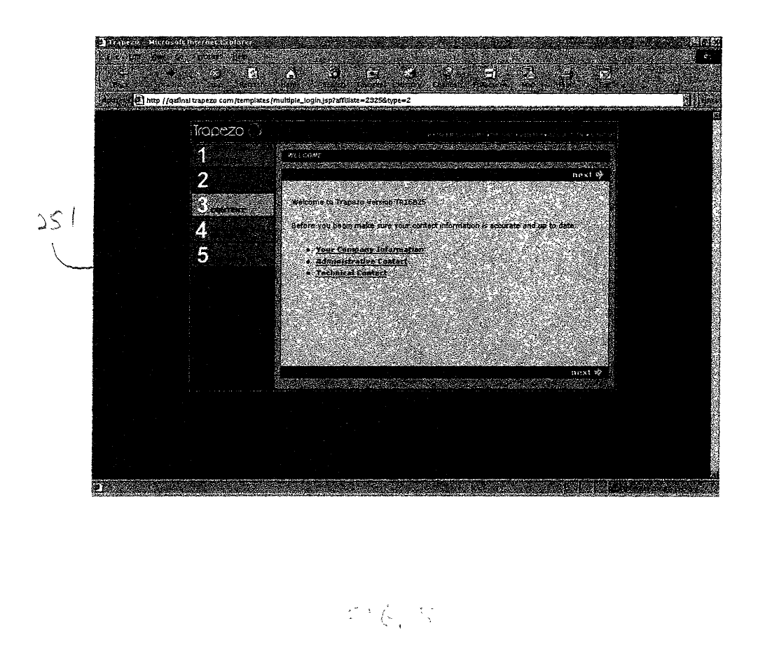

Now that a high level description of embodiments of the invention have been described with reference to FIG. 3, it may be beneficial to describe a method of delivering shared content in more detail. FIG. 4 shows a flowchart of a process of delivering content from a distributor to a publisher so that the content will appear as specified by the publisher. At a step 201, content is received at a server from a distributor. The content can be received through either a pull or push technology and the content can be from any digital format. Additionally, the content can be received at the server from the distributor upon demand or at specified intervals.

In one embodiment, known techniques are utilized to retrieve the content from the distributor. An agent can be utilized to “scrape” the content from a data source of the distributor. As an example, web pages may be scraped by matching HTML tags to attributes. Additionally, a distributor can provide a data feed (e.g., XML or Comma Delimited Format) from which the content can be extracted. Additionally, a distributor can either specify a FTP server that the content could be gathered from or could deliver the content into a specified FTP server. As another example, a component may be installed on a database of the distributor in order to send the desired content to the server. The above indicates just a few of the techniques that can be used to retrieve content from the distributor and other techniques may be advantageously applied in some applications so the invention is not limited to any specific implementation.

At a step 203, one or more rules specified by the publisher or the distributor are applied to adjust the selection and appearance (or format) of the content for presentation. Typically, the content includes one or more attributes. For example, content such as news may include attributes relating to the title, the author, the news source, and the like. The rules may specify the format that an attribute should be presented. Rules may also depend on specific attributes. Rules may also depend on the value of the relationship. Rules may also depend on the display case instance.

The content is delivered to the publisher at a step 205 so the content will appear as specified by the one or more rules. At a step 207, aspects of the process are tracked and reported. In some embodiments, the server tracks information on the content that has been delivered to the publisher. Additionally, the server can generate a report on the content that has been delivered to the publisher.

FIG. 5 shows a screen display of an embodiment that enables sharing of content between or among partners. In this embodiment, a web page 251 allows a partner to manage their relationships easily through the Internet. Initially, a customer is requested to enter company information, and administrative contact and a technical contact through web page 251. Other web pages of this embodiment will be described in the description that follows to aid in illustrating the invention, however, the description of this embodiment is for illustration purposes and not limitation.

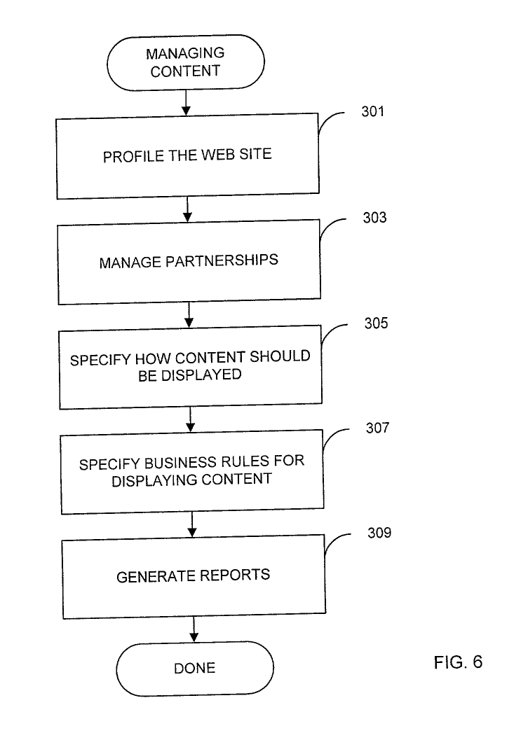

FIG. 6 shows a flowchart of process of managing content in a channel system. In the flowcharts shown herein, no order should be necessarily to the steps shown and the steps can be reordered, combined, deleted, and added without departing from the spirit and scope of the invention.

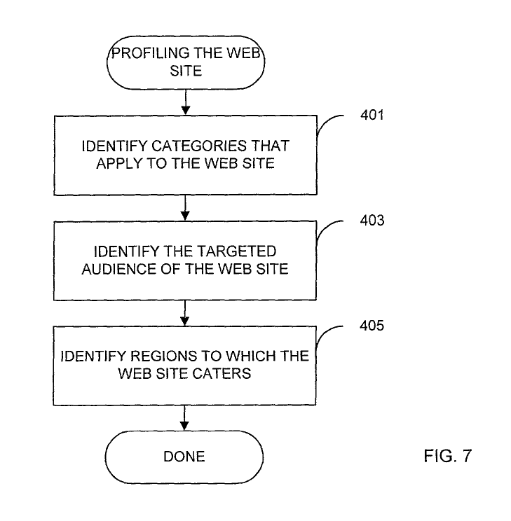

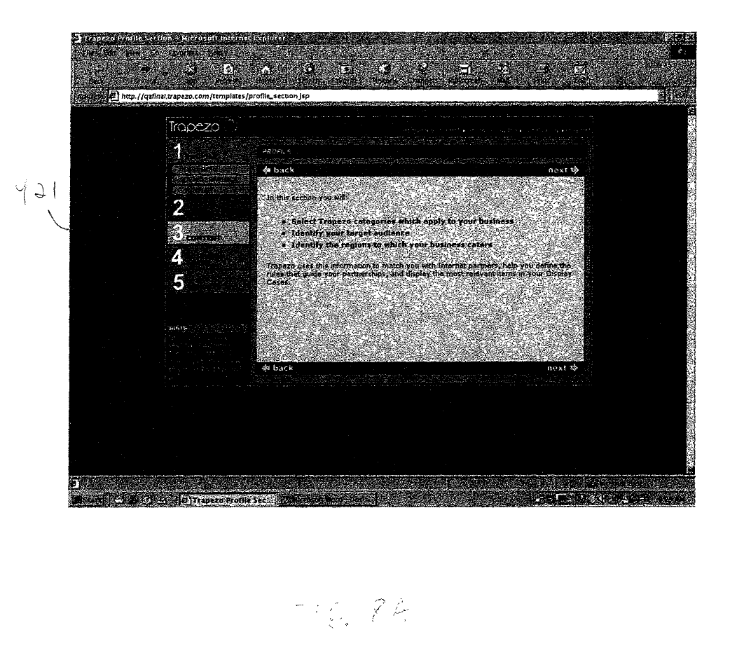

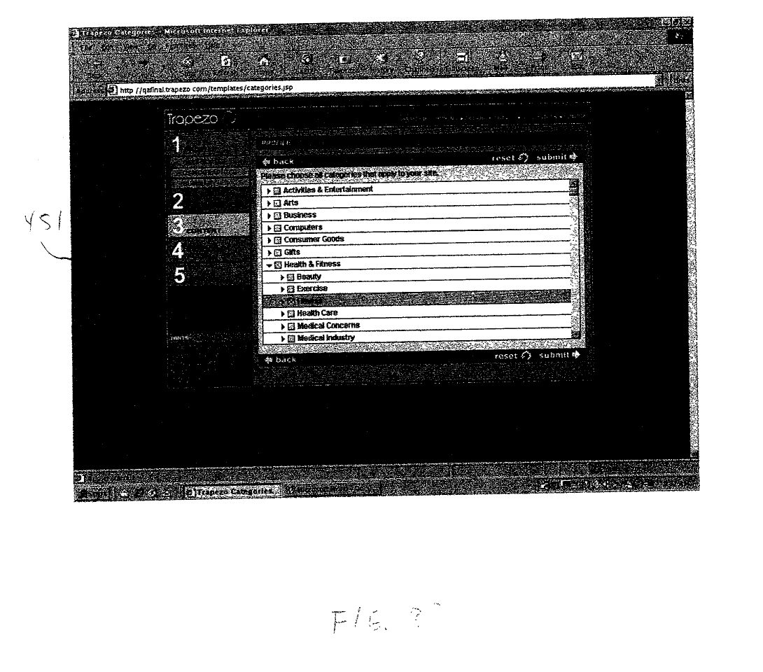

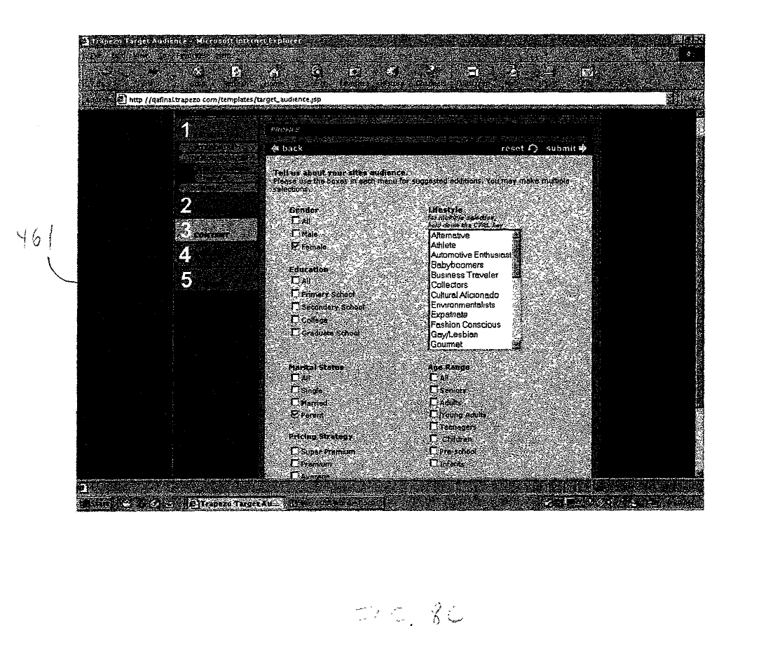

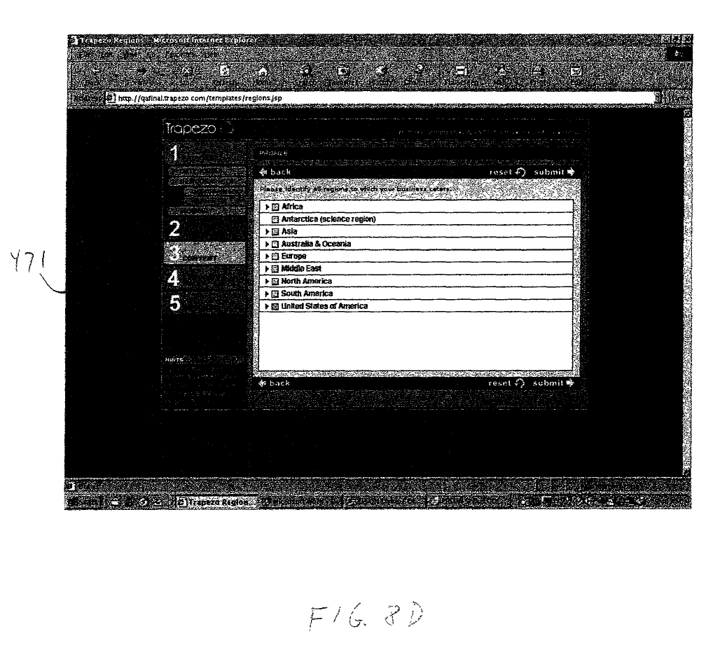

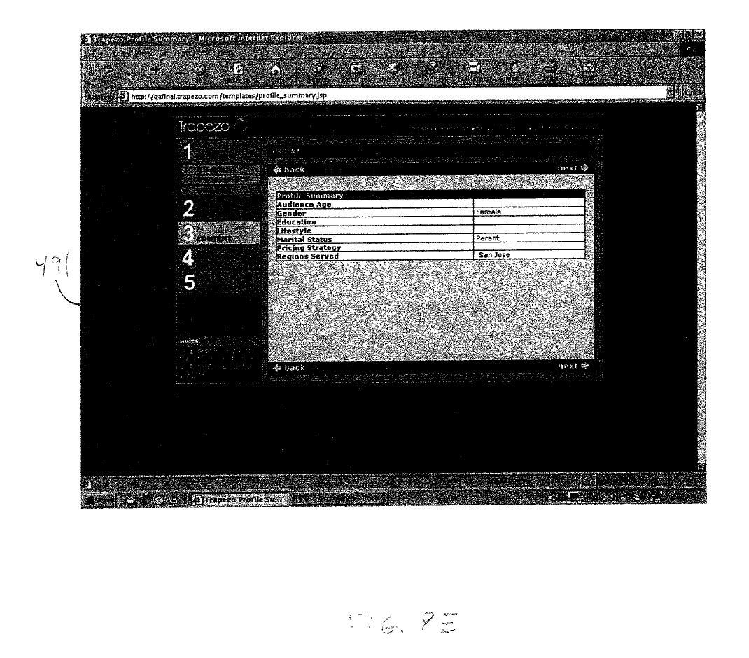

At a step 301, a Publisher that is to display shared content is profiled. Profiling the Publisher typically includes specifying categories (e.g., “sports equipment”) that are applicable to the Publisher. Additionally, the publisher may specify the typical viewers of the Publisher and where these viewers live. The information regarding a profiled Publisher can be utilized to identify potential partners and further details will be described in reference to FIGS. 7 and 8A-8E.

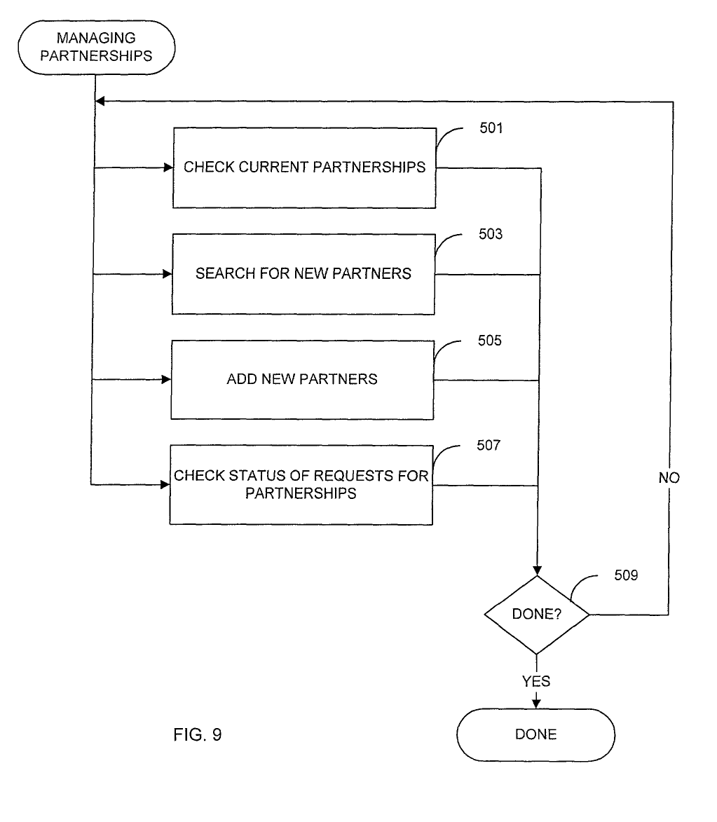

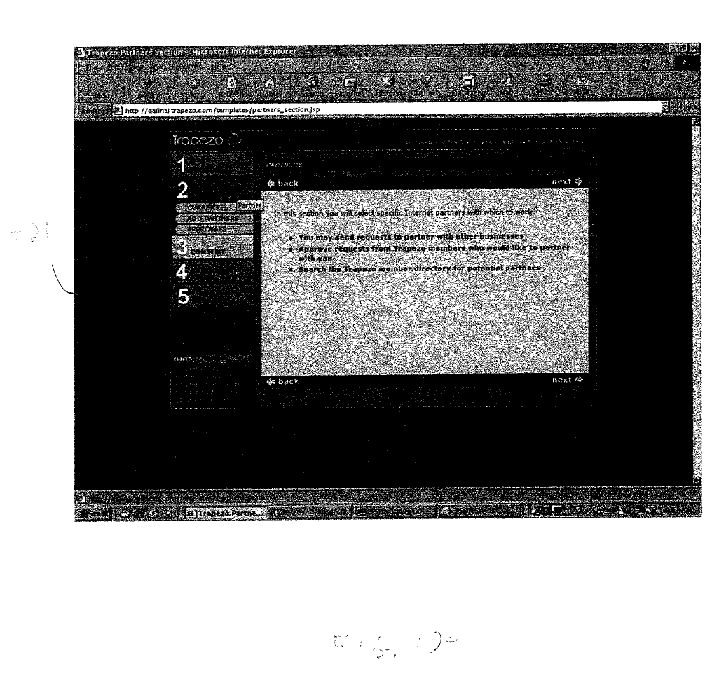

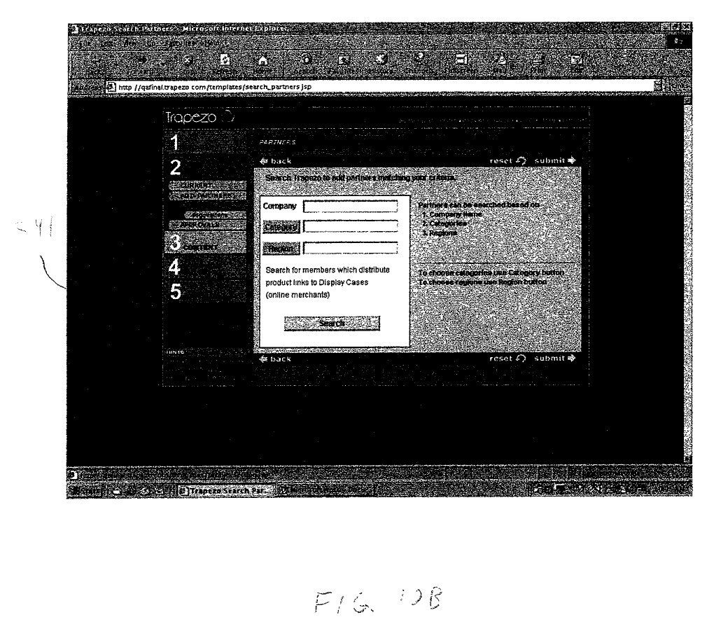

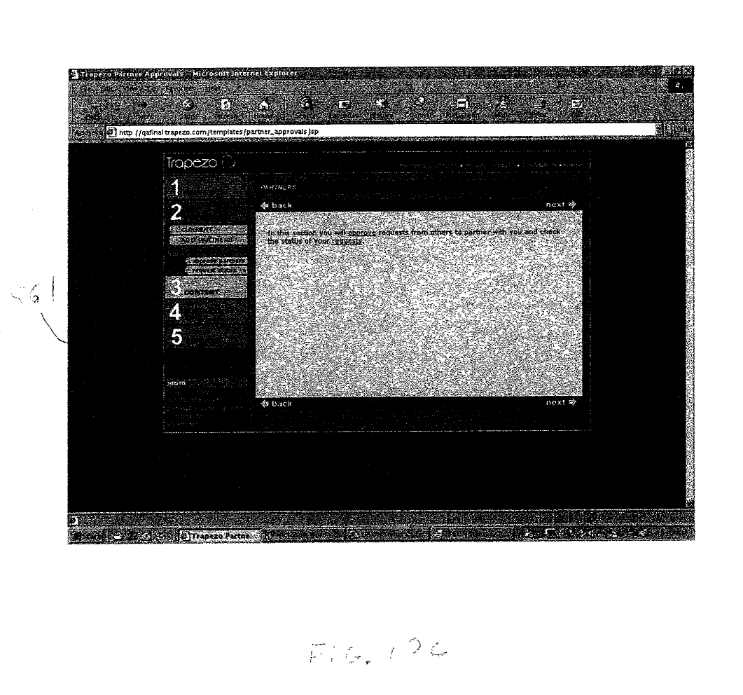

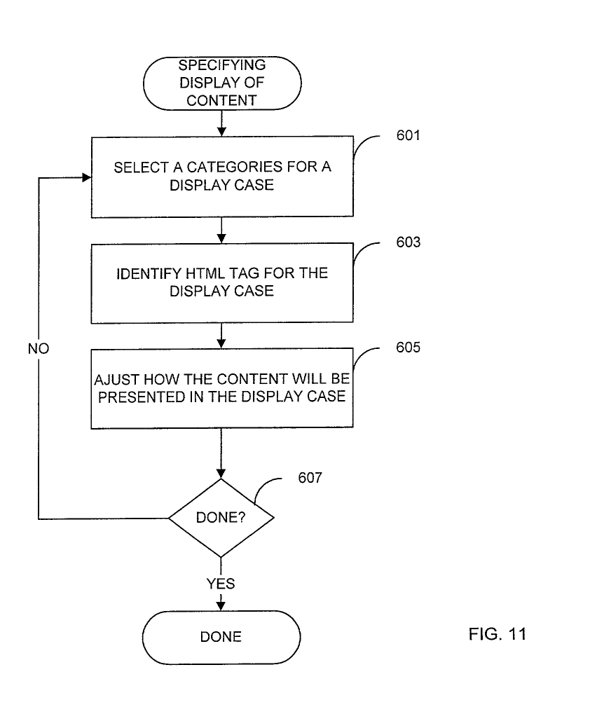

Relationships can be managed at a step 303. In managing relationships, the current status of relationships can be analyzed. Additionally, a partner can search for new partners, add new partners and check the status of requests for new relationships. Further details on managing relationships will be described in reference to FIGS. 9 and 10A-10C.

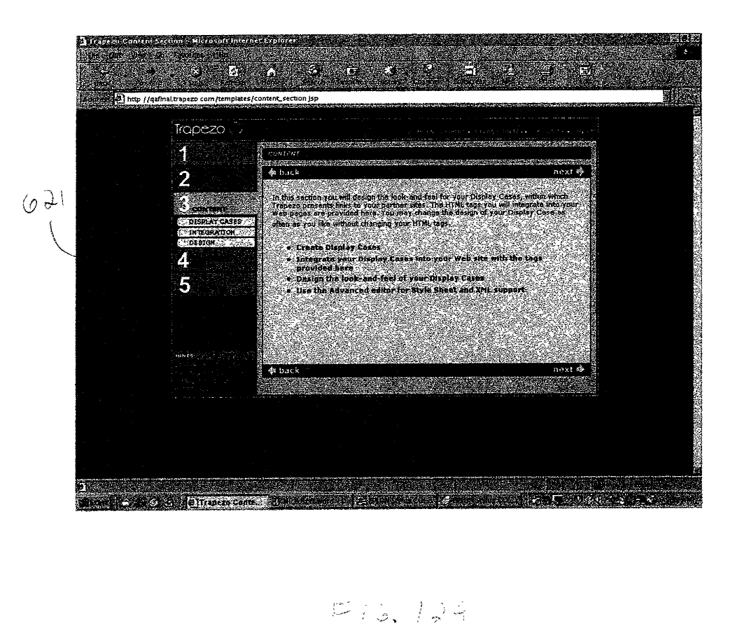

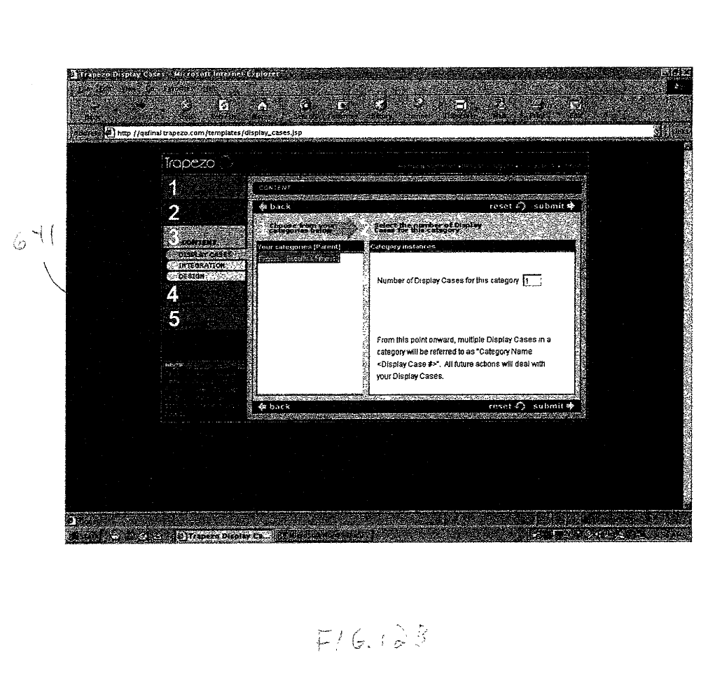

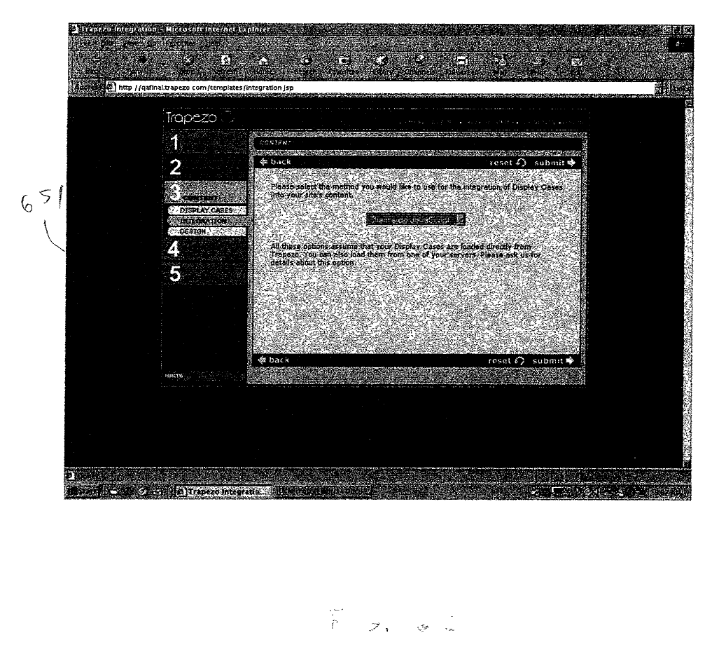

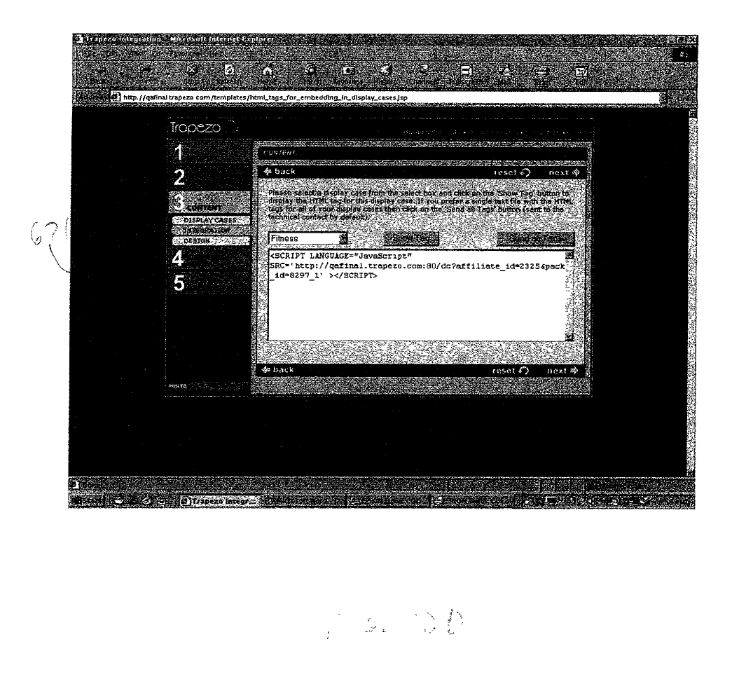

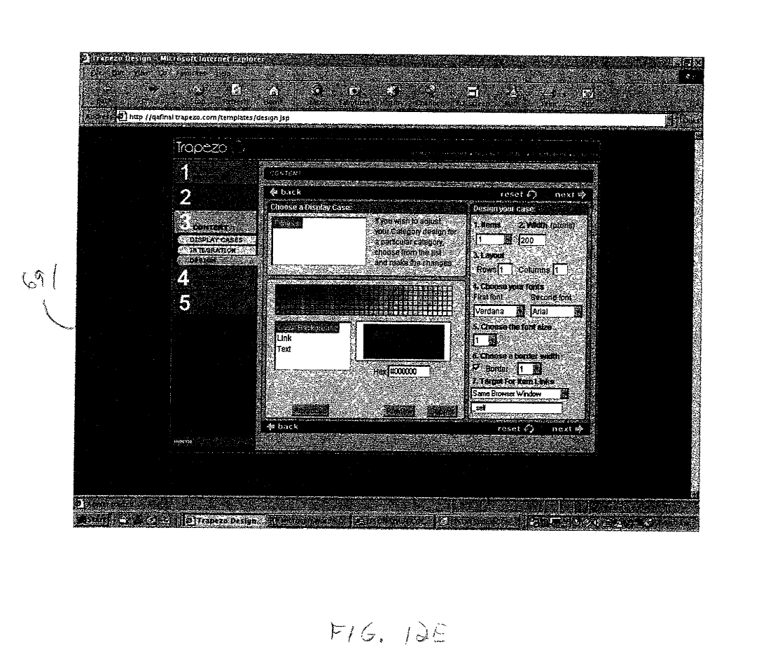

At a step 305, a publisher specifies how content should be displayed. Typically, a publisher has multiple display cases that can be utilized to present shared content. A publisher selects a display case and can adjust how the shared content should appear in the display case. For example, publisher can specify colors, size, layout, font, font size, and border of the display case. These specifications can be provided via using the user interface, via directly entering in the HTML tags into the system, via specifying the Publisher site stylesheet tags or via XSLT tags. This can allow the publisher to make shared content appear the same as content provided by the publisher. More details about specifying how shared content should be displayed will be described in more detail in reference to FIGS. 11 and 12A-12E.

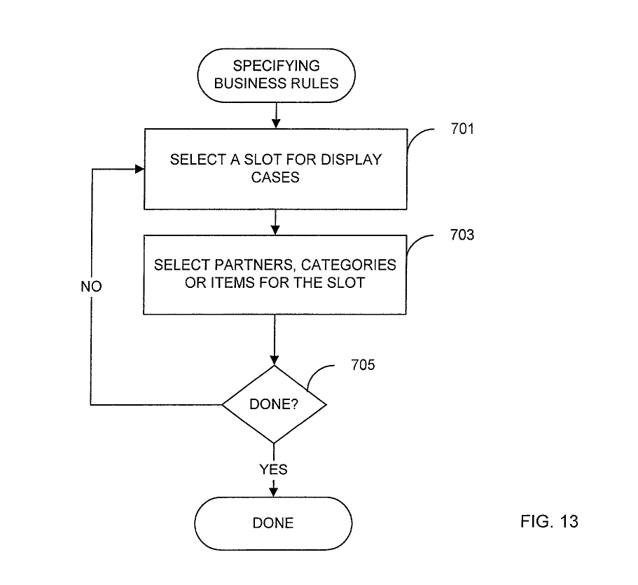

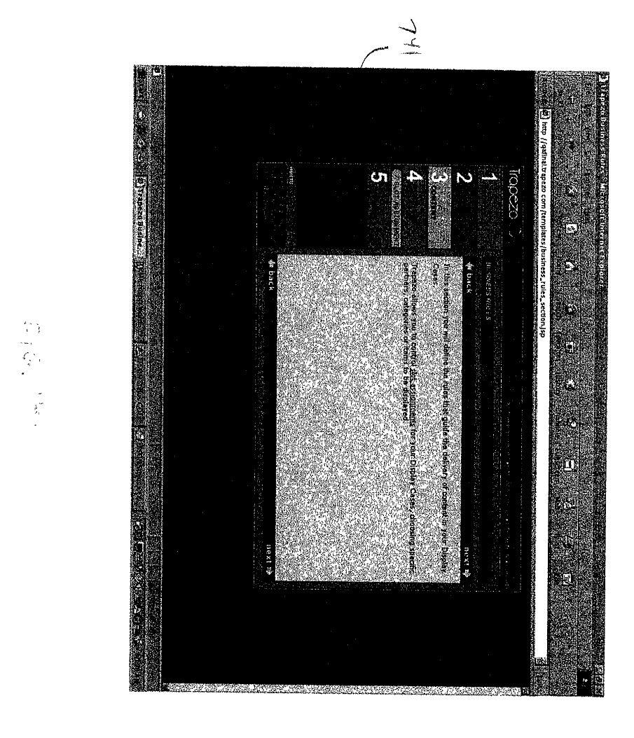

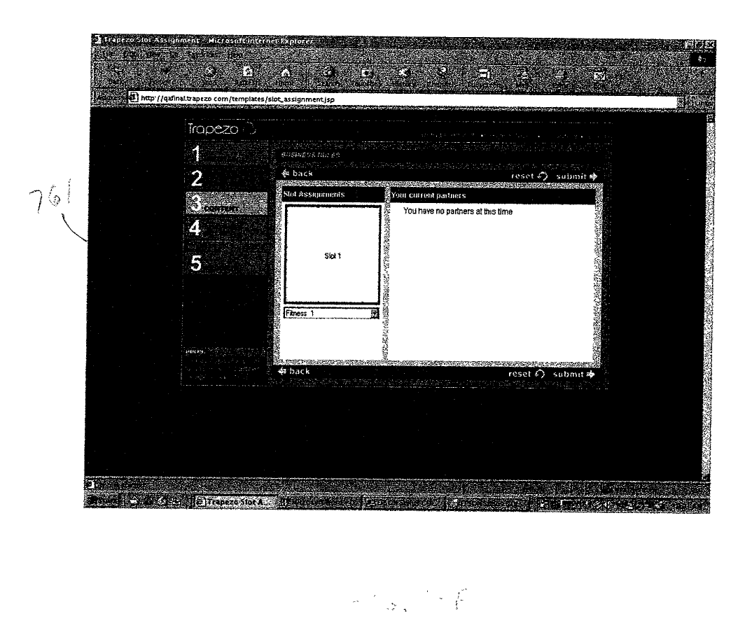

Business rules for displaying content can be specified at a step 307. The business rules can include specifying the partners, categories or items for each display case. Thus, even where the shared content to be displayed can dynamically change, a publisher can specify which types of shared content should be presented in a display case. Further details of specifying business rules for displaying content will be described in reference to FIGS. 13 and 14A-14B.

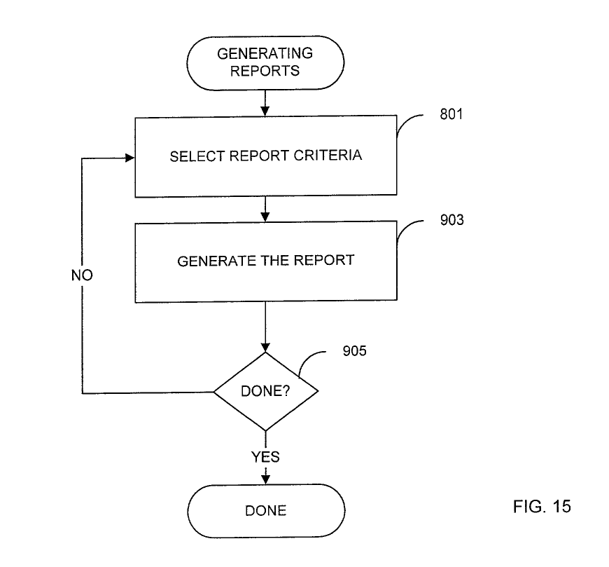

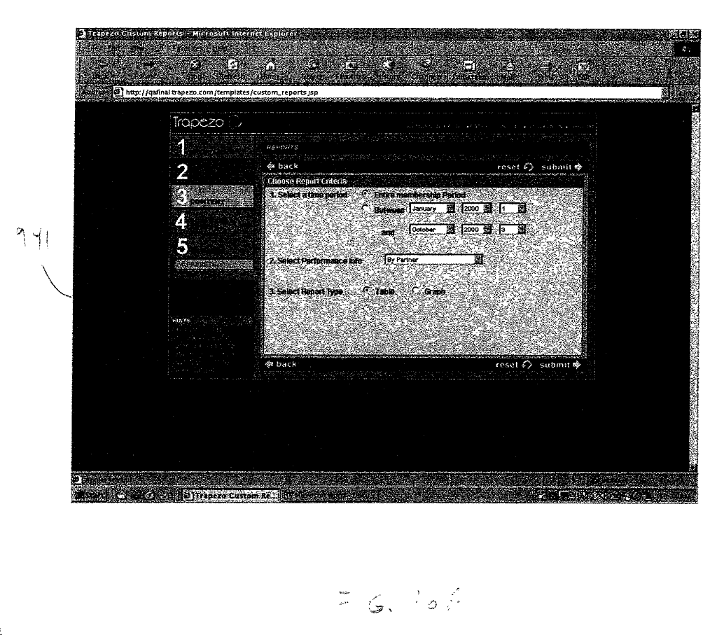

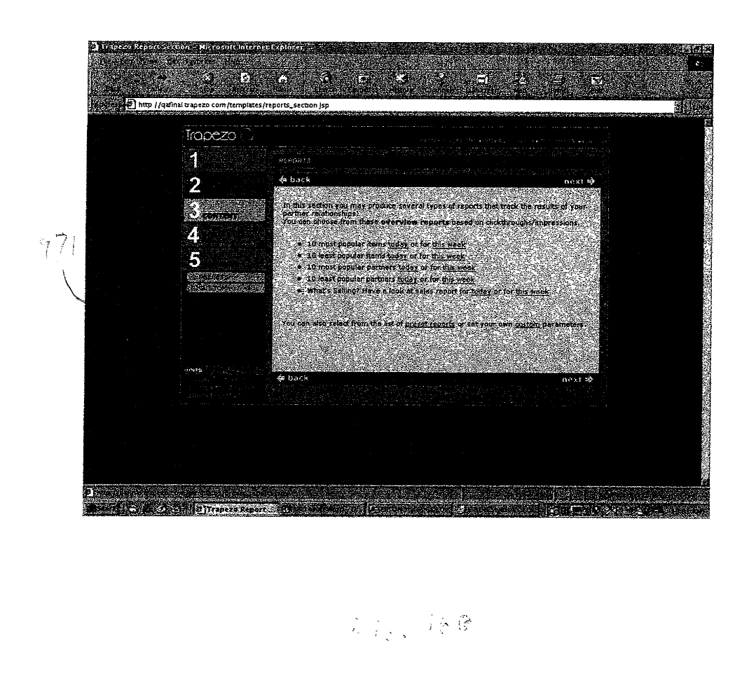

At a step 309, reports can be generated regarding the shared content that has been presented to consumers. The reports can detail such information as the shared content that has been presented, the traffic generated from the presented content, the sales that were made from displaying the shared content, information on the consumers, time of day the shared content was presented common, and the like. These reports are available on, but not limited to, a per publisher basis, per distributor basis, across categories, across different display cases, across different content items etc. Typically, the content server tracks the information that will be utilized in the reports, which allows partners to analyze the success of their relationships and make changes where desired. For example, if a publisher determines that some shared content has better success when presented during the day and other shared content has better success when presented at night, the publisher may adjust the business rules relating to the display cases to the shared content at times that have achieved the best results. Further details on generating reports will be described in reference to FIGS. 15 and 16A-16B.

FIG. 7 shows a flowchart of a process of profiling a Publisher for shared content. At a step 401, categories are identified that apply to the Publisher. Broad categories can be displayed initially and one or more of these broad categories can be selected or the broad categories can be expanded to show narrower categories, and so on. The targeted audience of the Publisher can be identified at a step 403. For example, the gender, educational background, marital status, age, lifestyle and the like can be specified in order to identify the targeted audience of the Publisher.

At a step 405, regions to which the Publisher caters can be identified. Like the categories, broad regions can be initially displayed which can be selected and these broad categories can be selected to further identify narrower regions.

FIGS. 8A-8E show screen displays of an embodiment that provides profiling and a Publisher's categories, target audience and regions. In FIG. 8A, a web page 421 indicates that in profiling a Publisher, categories that apply to the business, the target audience and the regions to which the business caters can be specified. This information can be utilized to match with other partners, define business rules for relationships and display the most relevant shared content in the display cases.

FIG. 8B shows a web page 451 that indicates categories that can apply to Publishers. As shown, check boxes can be used to indicate the categories that apply to a Publisher and broader categories can be expanded to show narrower categories. In FIG. 8B, the category (or sub-category) “Fitness” has been selected, which is in the broader category of “Health & Fitness.”

FIG. 8C shows a web page 461 that can be utilized to specify the target audience. As shown, the gender, education, marital status, pricing strategy, lifestyle, and age range can be indicated for what is anticipated is the target audience of the Publisher. As shown, the check boxes indicate that the target audience in this example are female parents.

FIG. 8D shows a web page 471 that allows the identification of regions to which the business caters. Once again broad regions are displayed, which can be expanded to show narrower regions. In this example, the region “United States of America” has been selected. A web page 491 shown in FIG. 8E shows a summary of the profile that has been specified for the Publisher.

FIG. 9 shows the flowchart of a process of managing relationships of sharing content. The process shown is an interactive and may be continued until the partner is finished. At a step 501, a partner can check on the status of relationships.

A search can be performed for new partners at a step 503. The search can be directed by specifying criteria for the types of new partners that are desired. At a step 505, new partners can be added. Adding new partners can include accepting requests for relationship and requesting relationship with other partners.

The status of requests for relationships can be checked at a step 507. If the partner is finished at a step 509, the process of managing relationships can be complete. Otherwise, the relationships can continue to managed.

FIGS. 10A-10C show screen displays of an embodiment that provides searching for potential partners, requesting relationships and accepting relationships. FIG. 10A shows a web page 521 that indicates that one can send requests to partner with other businesses, approve requests of others that would like to become partners and search for potential partners.

FIG. 10B shows a web page 541 that allows a partner to specify criteria and then search for a partner that matches the criteria. The criteria can include a company name, categories to which the partner's business relates and regions to which the partner's business caters. A web page 561 in FIG. 10C shows that requests from others to become a partner can be approved and the status of one's request to become partners with others can be checked.

FIG. 11 shows a flowchart of specifying the display of shared content. As mentioned before, the portion of a web page that displays shared content can be called a “display case.” At a step 601, categories are selected for a display case. Thus, categories indicate the desired subject for the shared content in the display case.

The hypertext markup language (“HTML”) tag for the display case is identified at a step 603. The HTML tag is the HTML text that should be inserted in the publishers Publisher in order to present the display case. The text can also include instructions in the form of a script that can instruct the browser to retrieve the shared content from the content server.

At a step 605, the manner in which the content will be presented in the display case can be adjusted. As mentioned previously, the shared content can be displayed to better conform to the publisher's Publisher. Also, the publisher can specify that the shared content should be displayed in such a manner to stand out from the other content on the Publisher. If the publisher indicates that the appearance of more display cases should be edited at a step 607, the process returns to step 601.

FIGS. 12A-12E show screen displays of an embodiment creation of display cases, specifying how the display cases will be integrated and adjusting the appearance of the content in the display cases. FIG. 12A shows a web page 621 that indicates that the look-and-feel of the display cases can be designed. Additionally, tags will be provided that allow the display cases to be integrated into the publisher's Publisher.

A web page 641 in FIG. 12B shows that partners, categories or specific content items can be associated with display cases. The categories that are selected for the web pages specify the intended shared content that should be displayed in the display cases.

FIG. 12C shows a web page 651 that allows the publisher to select the method to be used to integrate the display cases into the publisher's Publisher. Typically, the content for the display cases are loaded directly from the content server utilizing scripts (e.g., JavaScript). Additionally, the shared content can also be stored on the publisher's server system.

A web page 671 in FIG. 12D shows the HTML text that can be added to the publisher's web page to retrieve the shared content for a display case. In a preferred embodiment, the HTML text includes a link to the content server so that when a customer accesses the link, the content server is able to track information about the consumer, shared content, transaction, and the like. The HTML text can be inserted into the publisher's web page utilizing a standard editor.

FIG. 12E shows a web page 691 that allows a publisher to specify how the shared content in a display case should appear. As shown, colors for the background, link and text can be specified. Additionally, the size, layout, font, font size, and border can be specified by the publisher.

FIG. 13 shows a flowchart of a process of specifying business rules for the selection and displaying of content. At a step 701, a slot for display cases is selected. The partners, categories or items for the slot can then be selected at a step 703. These business rules allow the publisher to specify further criteria for the display of shared content within the display cases. If the publisher indicates that other business rules are to be specified for another slot at a step 705, the process returns to step 701. Other rules include but are not limited to rules based on specific content attributes, relationship priorities, popularity and end customer profiles.

FIGS. 14A-14B show screen displays of an embodiment that provides specification of business rules in the display of content in display cases. In FIG. 14A a web page 741 indicates that the publisher can define rules that guide the delivery of content into the display cases. As shown in FIG. 14B a web page 761 allows the publisher to select a slot and also specify categories and/or partners that should be utilized to identify the shared content for the display cases in the slot.

FIG. 15 shows a flowchart of a process of generating reports the shared content. At a step 801, report criteria are selected. The report is then generated based on the criteria at a step 903. If the user indicates that more reports should be generated at a step 905, the process returns to step 801.

FIGS. 16A-16B show screen displays of an embodiment that provides customization of reports that are generated regarding the shared content. FIG. 16A shows a web page 941 that allows the user to specify report criteria such as the time period, performance information (e.g., by partner) and the report type. Additionally, a web page 971 shown in FIG. 16B shows some standard reports that can be generated to analyze the results of the relationships. For example, a report can be selected that shows the ten most popular items that were sold this week through the shared content showed in display cases on the publisher's Publisher. Thus, embodiments of the invention allow for the generation of preset or custom reports.

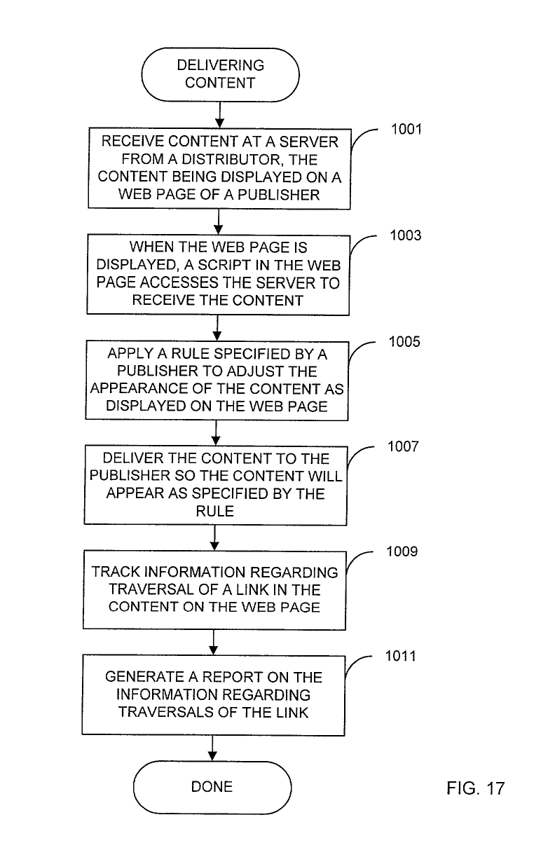

FIG. 17 shows a flowchart of a process of delivering content from a distributor to a publisher so that the content will appear on a Publisher as specified by the publisher. At a step 1001, content is received at a server from a distributor. The content that is received will be displayed on a web page of a publisher. When the web page is displayed, a script in the web page access the server to receive the content at a step 1003.

At a step 1005, the server applies a rule specified by a publisher to adjust the appearance of the content as displayed on the web page. Typically, the content includes at least one attribute and the rules specify the format that the attribute should be presented on the web page.

The content is delivered to the publisher so the content will appear specified by the rule at a step 1007. At a step 1009, the server tracks information regarding traversal of a link in the content of the web page. The link in the web page causes the server to be accessed when a customer traverses the link. Thus, the server can track information regarding traversal of the link and any other information regarding the transaction. For example, the server can track the shared content, information regarding the customer (e.g., click through data), and information regarding the transaction (e.g., date and time).

At a step 1011, a report is generated on the information regarding the traversals of the link in the web page of the publisher. In one embodiment, the shared content shown in display cases is dynamically selected by the content server in order to attempt to maximize the success of the relationship.

With embodiments of the invention, content sharing relationships can be made easily, efficiently and without a great expenditure of resources. The success of the relationships can be monitored and adjusted in order to maximize the results from the relationships.

While the above is a complete description of preferred embodiments of the invention, various alternatives, modifications, and equivalents can be used. It should be evident that the invention is equally applicable by making appropriate modifications to the embodiments described above. Therefore, the above description should not be taken as limiting the scope of the invention that is defined by the metes and bounds of the appended claims along with their full scope of equivalents.

What is claimed is:

1. A computer implemented method of delivering content, comprising:
receiving content at a server from a distributor;
the server applying rules specified by a publisher or distributor to adjust the selection and appearance of the content;
the server delivering the content to the publisher so that the content will appear as specified by the rule; and
the server tracking and reporting on aspects of the process.

2. The method of claim 1, wherein the content is received through either a pull or push technology.

3. The method of claim 1, wherein the content is received at the server upon demand.

4. The method of claim 1, wherein the content is received at the server from the distributor at specified intervals.

5. The method of claim 1, wherein the content is news, products or services.

6. The method of claim 1, wherein the content includes at least one attribute.

7. The method of claim 6, wherein one or more rules specify the selection and format for content presentation.

8. The method of claim 1, wherein the server tracks and reports one or more of receiving content, applying rules or delivering content.

9. The method of claim 1, further comprising the server tracking information on the content that has been delivered to the publisher.

10. The method of claim 9, further comprising the server generating a report on the information that has been delivered to the publisher.

11. A channel content management system, comprising:
a distributor system that stores content;
a server that receives the content from the distributor system and applies one or more rules specified by a publisher or distributor to adjust the selection and appearance of the content;
a publisher system that receives the content from the server so that the content will appear as specified by the rule; and
the server tracks and reports on aspects of the process.

12. The system of claim 11, wherein the first server receives the content through either a pull or push technology.

13. The system of claim 11, wherein the publisher system that receives the content from the server upon demand.

14. The system of claim 11, wherein the server receives the content from the distributor system at specified intervals.

15. The system of claim 11, wherein the content is news, products or services.

16. The system of claim 11, wherein the content includes at least one attribute.

17. The system of claim 11, wherein the one or more rules specify the selection and format for content presentation.

18. The system of claim 11, wherein the server tracks information on the content that has been sent to the publisher system.

19. The system of claim 18, wherein the server generates a report on the content that has been sent to the publisher system.

20. A computer implemented method of delivering content, comprising:
receiving content at a server from a distributor, the content being displayed on a web page of a publisher;
when the web page is displayed, a script in the web page accesses the server to receive the content;
the server applying rules specified by a publisher or distributor to adjust the selection and appearance of the content;
the server delivering the content to the publisher so that the content will appear on the web page as specified by the rules; and
the server tracking and reporting on aspects of the process.

21. The method of claim 20, wherein the content on the web page includes a link to the server.

22. The method of claim 21, further comprising the server tracking information regarding traversal of the link.

23. The method of claim 20, further comprising the server generating a report on the information regarding traversals of the link.

24. The method of claim 20, wherein the content is news, products or services.

25. The method of claim 20, wherein the content includes at least one attribute.

26. The method of claim 25, wherein one or more rules specify the selection and format for content presentation on the web page.

27. A channel content management system, comprising:
a distributor system that stores content, the content being displayed on a web page of a publisher system;
a server that receives the content from the distributor system and applies one or more rules specified by a publisher or distributor to adjust the selection and appearance of the content as displayed on the web page;
a publisher system that displays the web page and when the web page is displayed, a script in the web page accesses the server to receive the content so that the content will appear on the web page as specified by the rule; and
the server tracks and reports on aspects of the process

28. The system of claim 27, wherein the content on the web page includes a link to the first server.

29. The system of claim 28, wherein the second server tracks information regarding traversal of the link.

30. The system of claim 28, wherein the server generates a report on the information regarding traversals of the link.

31. The system of claim 27, wherein the content is news, products or services.

32. The system of claim 27, wherein the content includes at least one attribute.

33. The system of claim 27, wherein one or more rules specify the selection and format for content presentation on the web page.
